(19) United States
(12) Patent Application Publication
(10) Pub. No.: US 2024/0248684 A1
(43) Pub. Date: Jul. 25, 2024

(54) SEMICONDUCTOR DEVICE

(71) Applicant: Renesas Electronics Corporation, Tokyo (JP)

(72) Inventors: Shuji SENDA, Tokyo (JP); Katsumi TOGAWA, Tokyo (JP)

(21) Appl. No.: 18/404,789

(22) Filed: Jan. 4, 2024

(30) Foreign Application Priority Data
Jan. 19, 2023 (JP) 2023-006452

(51) Int. Cl. G06F 7/544; G06F 1/3234; G06F 7/487; G06F 7/509; G06N 3/063

(52) U.S. Cl. CPC G06F 7/5443; G06F 1/3234; G06F 7/4876; G06F 7/5095; G06N 3/063

(57) ABSTRACT

A semiconductor device according to one includes: an initial value setting unit configured to provide an initial value of a register that holds a cumulative value to be a result of a product-sum operation in a product-sum operation circuit; and an initial value canceling circuit configured to cancel the initial value contained in the cumulative value held by the register and output a final output value, and the initial value setting unit sets a positive or negative value other than zero as the initial value.

### CROSS-REFERENCE TO RELATED APPLICATIONS

The disclosure of Japanese Patent Application No. 2023-006452 filed on Jan. 19, 2023 including the specification, drawings and abstract is incorporated herein by reference in its entirety.

### BACKGROUND

The present invention relates to a semiconductor device, for example, a semiconductor device having a product-sum operation circuit.

There is disclosed a technique listed below.
[Patent Document 1] Japanese Unexamined Patent Application Publication No. 2022-012624

In recent years, the use of artificial intelligence utilizing machine learning has become popular, and techniques to realize the processing required for the machine learning with hardware have been actively developed. Patent Document 1 discloses an example of the technique to realize the machine learning with hardware.

Patent Document 1 discloses a semiconductor device comprising: a memory outputting a plurality of pieces of first data in parallel; a plurality of product-sum operation circuits corresponding to the plurality of pieces of first data; and a plurality of selectors: corresponding to the plurality of product-sum operation circuits; supplied with a plurality of pieces of second data in parallel; selecting one piece of second data from the supplied plurality of pieces of second data according to additional information indicating a position of one piece of second data to be calculated with one piece of first data by the corresponding product-sum operation circuits among the plurality of pieces of second data; and outputting the selected second data, wherein each of the plurality of product-sum operation circuits performs a product-sum operation between the first data different from each other in the plurality of first data and the second data outputted from the corresponding selectors.

### SUMMARY

However, the technique disclosed in Patent Document 1 has a problem in that the power consumption required for the product-sum operation increases.

Other problems and novel features will be apparent from the description of this specification and the accompanying drawings.

A semiconductor device according to one embodiment includes: an initial value setting unit configured to provide an initial value of a register that holds a cumulative value to be a result of a product-sum operation in a product-sum operation circuit; and an initial value canceling circuit configured to cancel the initial value contained in the cumulative value held by the register and output a final output value, and the initial value setting unit sets a positive or negative value other than zero as the initial value.

In the semiconductor device according to one embodiment, it is possible to reduce the power consumption required for the product-sum operation.

### BRIEF DESCRIPTION OF THE DRAWINGS

FIG. 1 is a block diagram of a semiconductor device according to the first embodiment.

FIG. 2 is a diagram showing an example of a neural network structure.

FIG. 3 is a schematic diagram showing a flow of an operation processing in a neural network.

FIG. 4 is a block diagram showing a configuration of a parallel operation circuit according to the first embodiment.

FIG. 5 is a block diagram showing a configuration of a product-sum operation circuit according to the first embodiment.

FIG. 6 is a diagram for describing an example of calculation result by the product-sum operation circuit according to the first embodiment.

FIG. 7 is a timing chart of a change of a register value by the product-sum operation circuit according to the first embodiment.

FIG. 8 is a timing chart of a change of a register value by a product-sum operation circuit according to a comparative example.

FIG. 9 is a block diagram showing another example of the configuration of the product-sum operation circuit according to the first embodiment.

FIG. 10 is a flowchart for describing an example of a process flow from a weight determination in machine learning to an inference processing.

FIG. 11 is a block diagram showing a configuration of a product-sum operation circuit according to the second embodiment.

FIG. 12 is a diagram for describing a first example of an initial value determination method in the product-sum operation circuit according to the second embodiment.

FIG. 13 is a diagram for describing a toggle rate in the case of applying the first example of the initial value determination method.

FIG. 14 is a diagram for describing a second example of the initial value determination method in the product-sum operation circuit according to the second embodiment.

FIG. 15 is a diagram for describing a toggle rate in the case of applying the second example of the initial value determination method.

FIG. 16 is a block diagram showing a configuration of a product-sum operation circuit according to the third embodiment.

FIG. 17 is a block diagram showing a configuration of a product-sum operation circuit according to the fourth embodiment.

FIG. 18 is a block diagram showing a configuration of a product-sum operation circuit according to the fifth embodiment.

### DETAILED DESCRIPTION

For clarifying the description, the following descriptions and drawings are omitted and simplified as appropriate. Further, in each drawing, the same elements are denoted by the same reference characters and redundant descriptions are omitted as necessary.

### First Embodiment

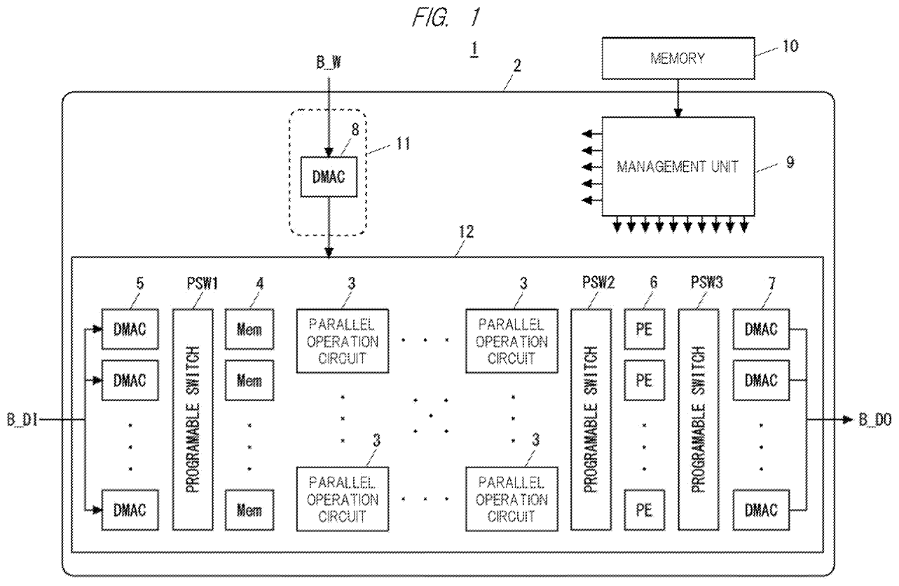

FIG. 1 shows a block diagram of a semiconductor device 1 according to the first embodiment. As shown in FIG. 1, the semiconductor device 1 according to the first embodiment includes an array processor 2 and a memory 10. The semiconductor device 1 shown in FIG. 1 is assumed to have the array processor 2 and the memory 10 formed on one semiconductor chip, but is not limited to this. Further, although circuit blocks other than the array processor 2 and the memory 10 are also mounted in the semiconductor device 1, these circuit blocks are omitted in FIG. 1.

The array processor 2 includes a management unit 9, a transfer path unit 11, and an array unit 12. Also, the array unit 12 includes parallel operation circuits 3, memories 4, direct memory access controllers (DMAC) 5 and 7, processor elements 6, and programmable switches PSW1 to PSW3. In the array unit 12, the memories 4, the DMACs 5 and 7, and the processor elements 6 are each formed as a circuit unit to implement an individual function, and a plurality of these circuit units are arranged.

The array processor 2 performs inference processing by a circuit configuration having a neural network structure. A plurality of descriptor strings are stored in the memory 10. The descriptor string includes information specifying the functions of the processor elements 6 in the array unit 12, information determining the states of the programmable switches PSW1 to PSW3 in the array unit 12, and the like. When the descriptor string is supplied to the management unit 9, the management unit 9 decodes the descriptor string, generates a corresponding control signal, and supplies it to the array unit 12 and the like. In this way, processing according to the descriptor string stored in the memory 10 by the user is realized in the array unit 12. In other words, the internal connections and states of the array unit 12 are determined by the management unit 9. Note that the descriptor may include information regarding the parallel operation circuit 3 in the array unit 12.

The transfer path unit 11 is connected between a bus B_W that transfers weight data and the like and the array unit 12, and transfers the weight data and the like to the array unit 12. The array unit 12 processes input data from a bus B_DI and outputs processed results to a bus B_DO as output data. When performing this processing, the array unit 12 uses the weight data and the like. Here, the weight data used in the semiconductor device 1 according to the first embodiment is a value to be a coupling coefficient between neurons, and is hereinafter referred to as a weight parameter in some cases.

Further, the transfer path unit 11 includes a direct memory access controller (DMAC) 8. The DMAC 8 transfers the weight data on the bus B_W to the memory 4. At least a part of the memories 4 are used as a local memory of the parallel operation circuit 3. Note that the memories 4 may include those used when performing the processing in the array unit 12.

Here, the functions of the circuit blocks in the array unit 12 will be described. The DMAC 5 stores input data from the bus B_DI in the memory 4 according to the programmable switch PSW1. The programmable switch PSW1 switches, according to instructions from the management unit 9, to which parallel operation circuit 3 the input data input from the DMAC 5 is provided.

The parallel operation circuit 3 performs a product-sum operation in parallel between the weight data stored in the memory 4 and the input data transferred by the DMAC 5. The parallel operation circuit 3 will be described later in detail with reference to the drawings. Note that, by arranging the parallel operation circuits 3 at the center of the array unit 12, it is possible to shorten the distance between the parallel operation circuits 3. Therefore, the arrangement shown in FIG. 1 is suitable for the cases where the operation performance of the parallel operation circuits 3 affects the performance of the application to be an object of processing performed by the array processor 2.

The memory 4 functions as a local memory of the parallel operation circuit 3 as described above. Further, the memory 4 may store the results of activation processing performed by the processor element 6 to be described later in addition to the above-mentioned weight data, and may hold the stored activation processing results so as to use it as input data to be provided to the parallel operation circuit 3 in the subsequent product-sum operations. In addition, in the product-sum operation processing in which the results of the activation processing performed in the processor element 6 are processed as input data, it is also possible to provide input data from an external memory (not shown in FIG. 1).

The processor element 6 is a circuit block capable of implementing various functions. The functions implemented by the processor element 6 are determined according to control signals from the management unit 9. Further, the programmable switches PSW2 and PSW3 also electrically connect designated circuit blocks according to the control signals from the management unit 9. For example, according to the control signal from the management unit 9, a predetermined processor element is set to have a function of performing a predetermined operation. Furthermore, the predetermined programmable switches PSW2 and PSW3 are set to connect, for example, the predetermined parallel operation circuit 3 and the predetermined processor element 6 according to the control signal from the management unit 9. Although an example in which the array unit 12 includes the plurality of processor elements 6 has been described here, the array unit 12 is not limited to this.

For example, a specific processor element of the processor elements 6 may be changed to a dedicated circuit block whose function is determined in advance. Namely, it is possible to set a batch normalization function in one processor element 6, and set a dedicated circuit block that performs activation processing in another processor element 6. By replacing general-purpose processor elements with dedicated circuit blocks in this way, it is possible to improve processing efficiency and speed. It is assumed that the activation processing described below is performed by any of the processor elements 6.

The DMAC 7 writes the operation result generated by applying the function set in the processor element to the operation result calculated by the parallel operation circuit 3 to, for example, an external memory (not shown in FIG. 1) as output data.

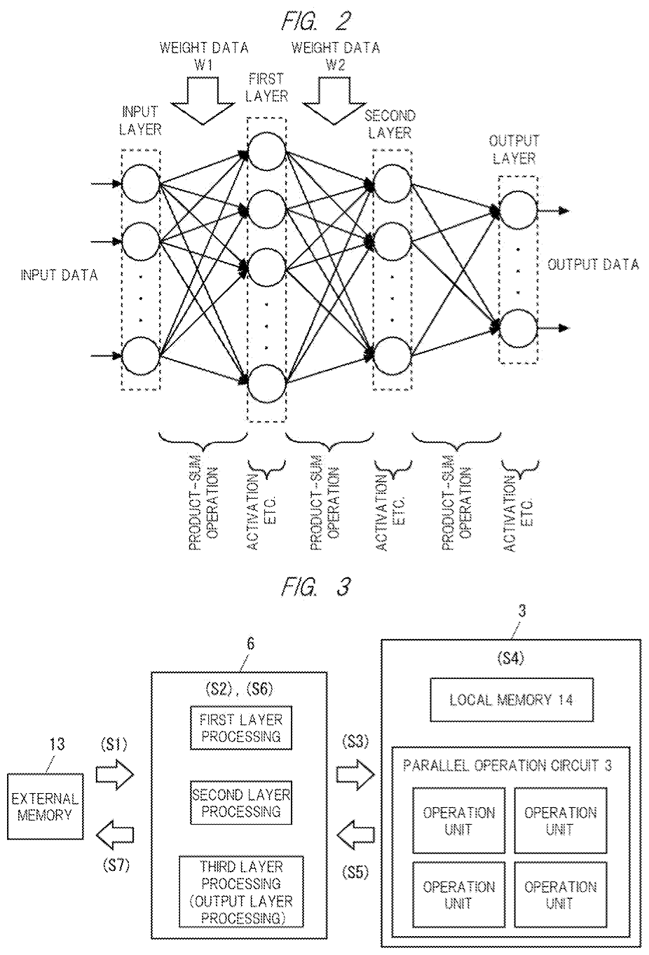

Next, the neural network structure realized in the semiconductor device 1 according to the first embodiment will be described. FIG. 2 is a diagram showing an example of a neural network structure. As shown in FIG. 2, in the neural network, neurons indicated by circles are arranged in layers, and the neurons between layers are connected using predetermined weight data as a coupling coefficient. The neural network in FIG. 2 shows the structure of a fully connected neural network in which each neuron arranged in a certain layer receives the outputs of all neurons arranged in the previous layer. In addition, FIG. 2 shows the structure of a four-layer neural network in which intermediate layers having a first layer and a second layer are arranged between an input layer and an output layer.

As shown in FIG. 2, in the operation of the neural network, a product-sum operation of multiplying input data by weight data W1 is performed, and an operation such as activation of the neurons arranged in the first layer is performed to the result of the product-sum operation. Thereafter, a product-sum operation of multiplying weight data W2 by the result of the operation (input data of the second layer) such as the activation of the neurons arranged in the first layer is further performed, and an operation such as activation of the neurons arranged in the second layer is performed to the result of the product-sum operation. Then, a product-sum operation and an operation such as activation are performed between the second layer and the output layer as in the first and second layers, thereby obtaining the final output data. As described above, many product-sum operations and processings such as the activation need to be performed in the neural network. Also, the processing of obtaining the operation result of the neural network by applying predetermined weight data to input data is referred to as inference processing, and the processing of obtaining the operation result of the neural network while updating the content of the weight data is referred to as machine learning.

The array processor 2 shown in FIG. 1 is suitable for convolution processing performed in inference processing. In the convolution processing, the same weight data is used a large number of times. Since the weight data is held in the memory 4 in the array processor 2, efficient processing is possible. FIG. 2 shows an example of full connection, in which the same weight data is not reused, rather than convolution processing.

An outline of operation processing in the neural network will be described with reference to FIG. 3 in addition to FIG. 2. FIG. 3 is a schematic diagram showing the flow of operation processing in the neural network. As shown in FIG. 3, the array processor 2 according to the first embodiment performs the procedure shown in FIG. 2 in the flow of operation processing. FIG. 3 shows an external memory 13 which is omitted in FIG. 1. However, this external memory 13 may be a memory formed on the same semiconductor substrate as the array processor 2. In the example shown in FIG. 3, input data is stored in the external memory 13, and the operation result obtained by the array processor 2 is written back into the external memory 13. Further, the memory 4 is illustrated as a local memory 14 of the parallel operation circuit 3. The weight data W1 and W2 are stored in this local memory.

Then, the array unit 12 first reads input data (feature) necessary for the operation from the external memory 13 (step S1). Subsequently, the configuration and state of the array unit 12 are set by the management unit 9 (step S2). Thereafter, the array unit 12 sequentially provides the input data read from the external memory 13 to the parallel operation circuit 3 (step S3). The parallel operation circuit 3 performs product-sum operation processing by multiplying the sequentially supplied input data by the weight data stored in the local memory 14 in the order of reception (step S4). The operation results of the product-sum operation by the parallel operation circuit 3 are sequentially output to the processor element 6 that realizes processing such as activation performed in the layer in which neurons are arranged shown in FIG. 2 (step S5).

In the array unit 12, operations such as addition and activation are performed using the processor element 6 as necessary to the data obtained by the parallel operation circuit 3 (step S6). Thereafter, the array unit 2 writes the output data obtained as a result of the operation into the external memory 13 as another feature (step S7). The processing in neural network is realized by such processing, and the semiconductor device 1 performs the operation processing necessary for inference processing by repeating such processing.

In the array processor 2 according to the first embodiment, the parallel operation circuit 3 performs regular product-sum operation processing among the necessary operation processings, so that the high speed processing can be realized. Further, operation processings other than the product-sum operation processing are performed by the processor element 6 whose circuit can be dynamically reconfigured by the management unit 9 or the like. In this way, it is possible to flexibly set the processing such as activation in each layer described as the first layer (first layer processing), the second layer (second layer processing), and the output layer (third layer processing) in FIG. 2 and FIG. 3. Furthermore, it is possible to set the number of parallel operation circuits to be used according to the necessary operation processing from among the plurality of parallel operation circuits 3 provided in advance in the array processor 2, and it is possible to set the number of processor elements to be used according to the necessary operation processing with respect to the processor elements 6 as well. Namely, it is possible to improve flexibility.

Here, the semiconductor device 1 according to the first embodiment has one feature in the configuration of the parallel operation circuit 3, and this feature realizes the reduction in power consumption. Therefore, the parallel operation circuit 3 will be described in detail below. FIG. 4 is a block diagram showing the configuration of the parallel operation circuit according to the first embodiment.

As shown in FIG. 4, the parallel operation circuit 3 includes the local memory 14, a selector group 15, a product-sum operation circuit group 16, and a latch 17. The latch 17 is serially supplied with input data (feature) DI that is generated in the array unit 12 and is to be subjected to a product-sum operation with weight data (for example, first data). Though not particularly limited, one input data DI is composed of a parallel bit array. The latch 17 is sequentially supplied with the input data DI in which input data to be one unit as parallel data is serialized and a plurality of pieces of data become continuous bit strings. The latch 17 parallelly outputs the string of m+1 supplied input data DI (m is an integer indicating the number of parallel processings of the product-sum operation processing) as data DL0 to DLm (for example, second data) based on a control signal SCC. For example, the first supplied input data DI is output and held as data DL0, the second supplied input data DI is output and held as data DL1, the third supplied data DI is output and held as data DL2, and the m+1-th supplied data DI is output and held as data DLm.

When the input data DI is high bit-width parallel data, the latch 17 may divide the supplied high bit parallel data into data DL0 to DLm and output them in parallel.

When the control signal SCC changes next, the latch 17 outputs and holds the m+2-th supplied input data DI as data DL0, outputs and holds the m+3-th supplied input data DI as data DL1, outputs and holds the m+4-th supplied data DI as data DL2, and outputs and holds the 2(m+1)-th supplied data DI as data DLm3. Thereafter, each time the control signal SCC changes, the latch 17 parallelly outputs and holds sequentially supplied m+1 input data DI in the same manner. In other words, the latch 17 is a conversion circuit configured to convert a serial data string into parallel data.

The selector group 15 includes a plurality of selectors (selectors 151 to 15m in FIG. 3) corresponding to the number of product-sum operation circuits. The selectors 151 to 15m are each connected to the corresponding local memory, latch 17, and product-sum operation circuit. The selectors 151 to 15m are unit selectors corresponding to product-sum operation circuits 161 to 16m, respectively. The data DL0 to DLm are commonly supplied from the latch 17 to the selectors 151 to 15m. Each of the selectors 151 to 15m is configured to select the data specified by additional information (described later) AD1 to ADm supplied from the local memory 14 from among the data DL0 to DLm, and supply the selected data to the corresponding product-sum operation circuit. The additional information mentioned here is the data indicating with which input data the weight data to be an object of operation is to be subjected to product operation. In other words, the additional information specifies which neuron in the previous layer the weight data to be an object of operation is the coupling coefficient with.

The local memory 14 is, for example, the memory 4. The local memory 14 includes a plurality of weight holding regions (for example, weight holding regions 141 to 14m), each of which can output independent weight data. The weight holding regions 141 to 14m hold weight data to be an object of the operation in the corresponding product-sum operation circuits. It is assumed that the weight data includes the above-mentioned additional information. Further, the weight holding regions 141 to 14m output weight data WD1 to WDm to the product-sum operation circuits 161 to 16m, respectively.

The product-sum operation circuit group 16 includes a plurality of product-sum operation circuits (for example, product-sum operation circuits 161 to 16m). The number m of product-sum operation circuits is determined by the number of parallel product-sum operations performed in the product-sum operation circuit group 16. The product-sum operation circuits 161 to 16m each perform a product operation of the input data provided from the corresponding selector and the weight data output from the weight holding region and a product-sum operation of adding the products between the input data and the weight data calculated for each processing cycle. In the semiconductor device 1 according to the first embodiment, the reduction in power consumption is achieved by the configuration of the product-sum operation circuit. Therefore, the configuration of the product-sum operation circuit will be described below in more detail.

In the semiconductor device 1 according to the first embodiment, a plurality of product-sum operation circuits 16 that can operate in parallel are provided in the parallel operation circuit 3, so that a large number of product-sum operation processings related to one processing layer can be performed in parallel. Further, in the semiconductor device 1 according to the first embodiment, a plurality of parallel operation circuits 3 are provided, so that the product-sum operation processings related to a plurality of processing layers can be performed in parallel. Accordingly, the semiconductor device 1 according to the first embodiment can perform inference processing at high speed.

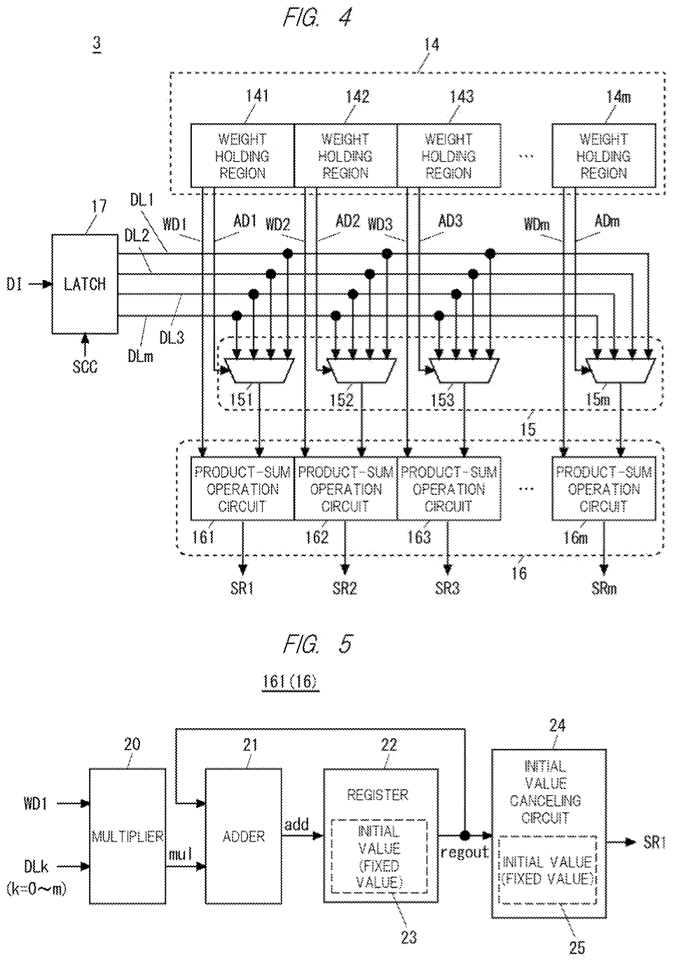

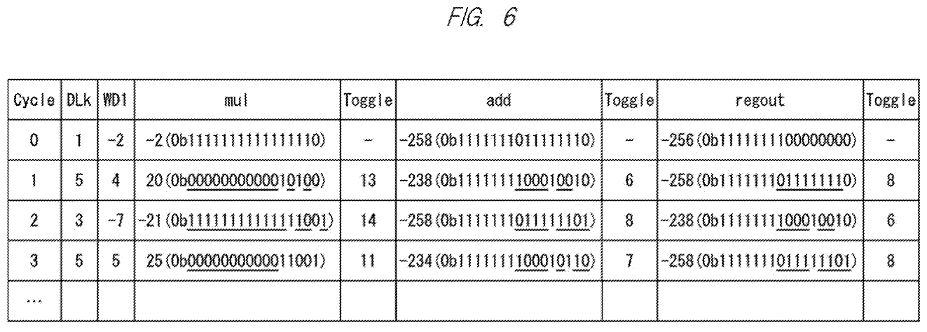

FIG. 5 is a block diagram showing the configuration of the product-sum operation circuit according to the first embodiment. Since the product-sum operation circuits 161 to 16m included in the product-sum operation circuit group 16 all have the same circuit configuration, the product-sum operation circuit according to the first embodiment will be described using the product-sum operation circuit 161 as an example.

As shown in FIG. 5, the product-sum operation circuit 161 according to the first embodiment includes a multiplier 20, an adder 21, a register 22, an initial value setting unit 23, an initial value canceling circuit 24, and an initial value holding unit 25. Further, in the semiconductor device 1, it is assumed that the product-sum operation processing is performed once in each processing cycle, and one final output value SR1 is determined by a plurality of product-sum operation processings performed while changing the combination of input data and weight data.

The multiplier 20 calculates the product of first data (for example, weight data WD1) and second data (for example, input data DLk) whose values change for each processing cycle, and outputs a product operation value mul. Here, the input data DLk is input data selected by the selector 151, where k is an integer between 0 and m. Also, the weight data is a value provided from the weight holding region 141.

The register 22 holds a value obtained by updating the cumulative value of the output values of the multiplier 20 (for example, the product operation value mul) for each processing cycle, and outputs it as a register value regout. The adder 21 adds the output value of the multiplier 20 (for example, the product operation value mul) and the register value regout to update the cumulative value. Here, the register 22 takes in the output value of the adder 21 in synchronization with a clock signal (not shown) and updates the register value regout by taking in the added value add output by the adder 21 as a cumulative value. The initial value canceling circuit 24 cancels the initial value contained in the register value regout and outputs the final output value SR1.

Here, in the first embodiment, the register 22 includes the initial value setting unit 23. The initial value setting unit 23 holds a preset initial value which is a fixed value, and the initial value setting unit 23 sets the register value regout to the initial value when resetting the register value regout of the register 22. Namely, the initial value setting unit 23 may be configured to set the reset value of the register to the initial value, and may be built in the register in terms of hardware. This initial value is a positive or negative value other than zero. More preferably, the initial value is set to such a size that the sign of the cumulative value is not inverted in the processing cycles until one final output value SR1 is determined.

In the semiconductor device 1 according to the first embodiment, input data and weight data may take both positive and negative values, and a phenomenon that the register value regout is switched between a positive value and a negative value occurs when an operation is performed with the initial value set to zero. In the register 22 that holds signed binary data, inversions of held hit values often occur due to switching of the sign of the held values. Therefore, in the product-sum operation circuit according to the first embodiment, the frequency of sign inversion of the register value regout is reduced by providing a positive or negative value as the initial value of the register value regout, whereby the toggle rate of circuits such as the flip-flops in the register 22 is reduced and the power consumption of the circuits is reduced.

Then, the operation of the product-sum operation circuit 161 when −256 is provided as the initial value of the register value regout will be described. FIG. 6 is a diagram for describing an example of calculation result by the product-sum operation circuit according to the first embodiment.

In FIG. 6, Cycle indicates the order of processing cycles, DLk indicates the value of input data, WD1 indicates the value of weight data corresponding to the input data, mul indicates the product operation value that is the output value of the multiplier 20, add indicates the added value that is the output value of the adder 21, regout indicates the register value, and Toggle indicates the number of bits in which inversion occurs between the previous processing cycle and the current processing cycle. Also, in FIG. 6, bits in which inversion occurs between the previous processing cycle and the current processing cycle are underlined. Further, it is assumed that the adder 21 of the product-sum operation circuit 161 shown in FIG. 5 is an asynchronous circuit that changes the added value add according to the input value without clock synchronization.

In the example shown in FIG. 6, the register value regout is set to the initial value −256 in cycle 0 which is the initialization cycle. Also, in cycle 0, the product operation value mul is determined by the product of the input data and the weight data. Further, in cycle 0, in response to the determination of the product operation value mul, the sum of the initial value of the register value regout and the product operation value mul becomes the added value add.

Subsequently, when the processing cycle becomes cycle 1 from cycle 0, the added value add of cycle 0 is taken into the register 22, so that the register value regout is updated by the added value add of cycle 0. At this time, eight bit values are inverted in the register value regout. Furthermore, in cycle 1, the product operation value mul is updated by the product of the input data and the weight data. Further, in cycle 1, in response to the determination of the product operation value mul, the sum of the register value regout updated in cycle 1 and the product operation value mul becomes the added value add.

As described above, in the product-sum operation circuit 161, by taking the added value add calculated in the previous processing cycle into the register 22 as a cumulative value, the register value regout, which is a cumulative value of the products of input data and weight data, is updated for each processing cycle, whereby the final output value SR1, which is a product-sum operation value of a plurality of combinations of input data and weight data, is determined.

Also, referring to FIG. 6, in the product-sum operation circuit 161 according to the first embodiment, the toggle in which the values of the upper seven bits are simultaneously inverted occurs in the product operation value mul due to the inversion of the sign. On the other hand, in the added value add and the register value regout whose value change ranges are shifted by the initial value, no inversion occurs in the upper seven bits corresponding to the sign part.

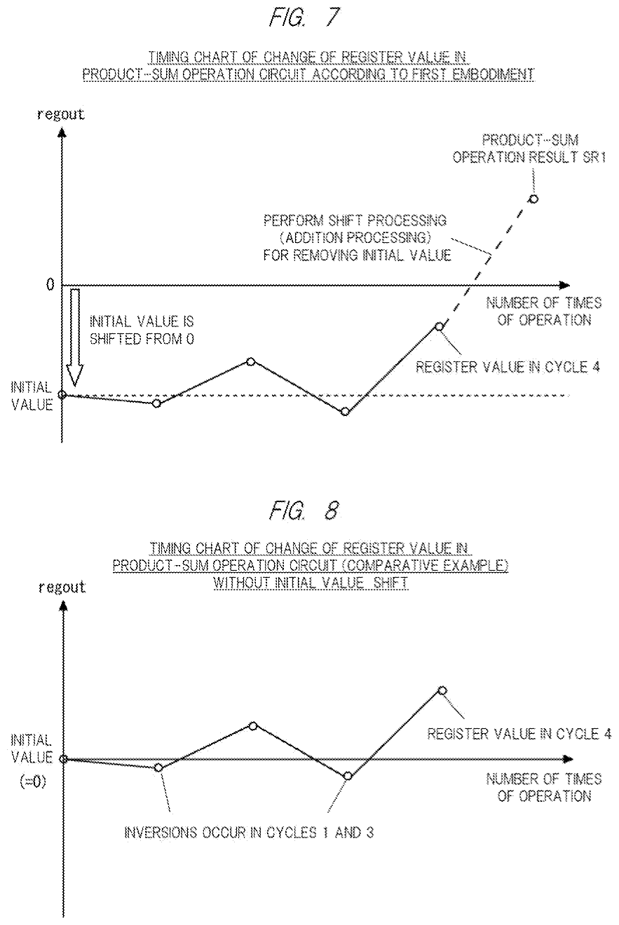

Next, the change of the register value regout shown in FIG. 6 by the number of times of operation (for example, the number of processing cycles) will be described. FIG. 7 is a timing chart of the change of the register value by the product-sum operation circuit according to the first embodiment. Note that the flowchart in FIG. 7 shows the process up to the determination of the final output value SR1 by the initial value canceling processing by the initial value canceling circuit 24.

As shown in FIG. 7, in the product-sum operation circuit 161 according to the first embodiment, the initial value is shifted in the negative direction at the start of processing. It is assumed that the shift amount at this time is fixed in the first embodiment. Then, from the initial value set as a start in cycle 0, the register value regout increases or decreases. However, since the initial value is shifted in the negative direction, the register value regout maintains a negative value even if the number of times of operation increases. Then, in the example shown in FIG. 7, the operation ends in cycle 4, the initial value component is removed from the register value regout by the initial value canceling circuit 24 at the next operation timing, and the final output value SR1 is determined. In the example shown in FIG. 7, the final output value SR1 is a positive value.

Here, FIG. 8 is a timing chart of the change of the register value by a product-sum operation circuit according to a comparative example, and the result of the product-sum operation processing performed to the same input data and weight data as those of FIG. 7 without the initial value shift processing will be described. Note that the product-sum operation circuit according to the comparative example is configured by removing the initial value setting unit 23 and the initial value canceling circuit 24 from the product-sum operation circuit shown in FIG. 5.

As shown in FIG. 8, in the operation by the product-sum operation circuit according to the comparative example, the phenomenon in which the register value regout switches between a positive value and a negative value occurs. If the sign inversion like this occurs, the number of transistors in which the toggle occurs increases in the register and the adder, and thus the power consumption increases.

From the foregoing description, in the semiconductor device according to the first embodiment, by setting the initial value held by the register 22 of the product-sum operation circuit 16 to a positive or negative value other than zero, the number of occurrences of sign inversion of the register value regout can be reduced, and the power consumption of the semiconductor device 1 can be reduced.

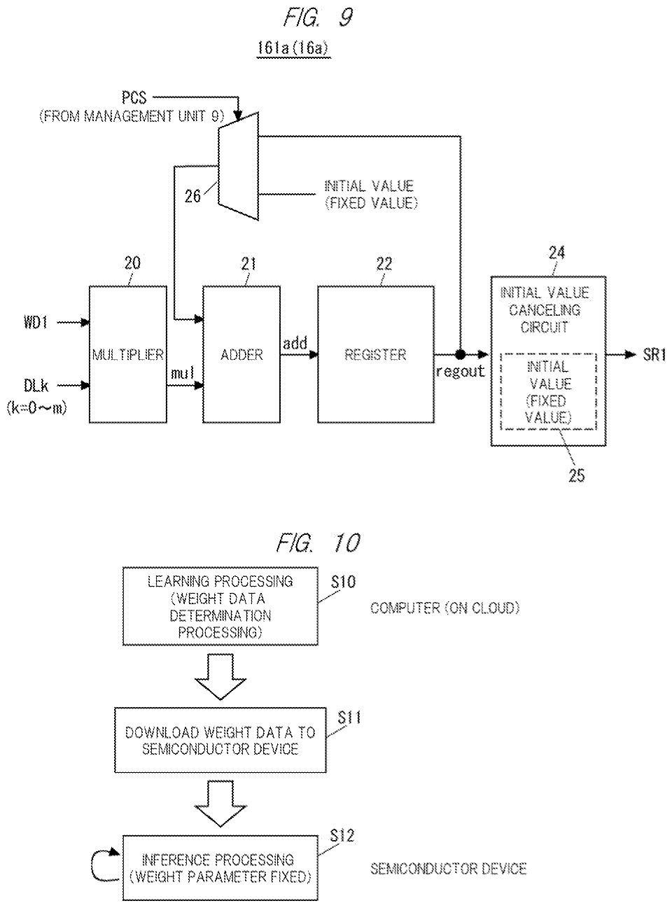

Here, as a modification of the product-sum operation circuit shown in FIG. 5, a configuration capable of exerting the same effect but having a different circuit form is conceivable. FIG. 9 is a block diagram showing another example of the configuration of the product-sum operation circuit according to the first embodiment.

A product-sum operation circuit 161a shown in FIG. 9, which is a modification of the product-sum operation circuit 161, is configured by removing the initial value setting unit 23 from the register 22 and adding a selector 26. For example, the selector 26 receives a control signal PCS instructing to start processing from the management unit 9 or the like, and provides the same initial value as that set by the initial value setting unit 23 to the adder 21 when the control signal PCS instructs to start processing. On the other hand, when the control signal PCS indicates that the processing cycle is other than the first cycle, the selector 26 provides the register value regout output from the register 22 to the adder 21. At this time, the reset value of the register 22 may be zero or other than zero. By using the selector 26 in this manner, even if the register 22 has already been designed, it is possible to omit redesign or verification work caused by the redesign.

### Second Embodiment

In the second embodiment, an initial value determination method in which the initial value is determined based on the number of times of operation and the size of weight data will be described. Note that, in the description of the second embodiment, the same components as those in the first embodiment are denoted by the same reference characters as those in the first embodiment, and the description thereof will be omitted.

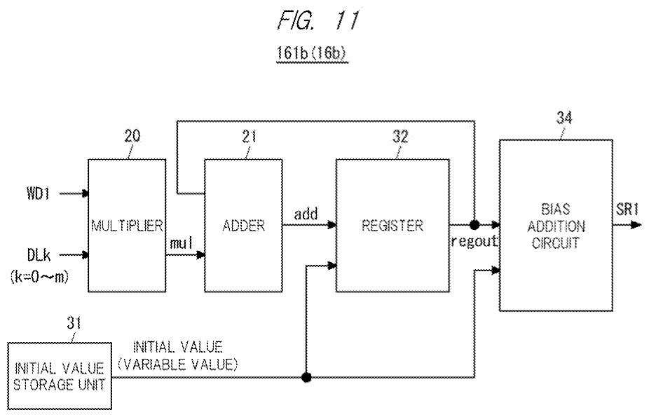

First, the operation of a machine learning system from the determination of weight data to the inference processing applied to the semiconductor device 1 will be described. FIG. 10 is a flowchart for describing an example of a process flow from the weight determination in machine learning to the inference processing. As shown in FIG. 10, in the machine learning system, the weight data is first determined by learning processing (step S10). Additional information is added to the weight data determined in step S10 in addition to the machine learning. Subsequently, the weight data is downloaded to the semiconductor device 1 (step S11). Thereafter, the semiconductor device 1 stores the downloaded weight data in the memory 4 and performs the inference processing (step S12).

Here, the machine learning does not need to use the semiconductor device 1, and can be performed on a computer or cloud system separate from the semiconductor device 1. Also, the weight data downloaded through the process shown in FIG. 10 is not updated by the learning processing. Therefore, when using the weight data that has become a fixed value, the upper and lower limit values of the register value regout resulting from the size of the weight data can be estimated, and it is thus possible to set the initial value size according to these estimates.

Therefore, a product-sum operation circuit 161b according to the second embodiment to which the initial value whose value can be changed by processing in this way is applied will be described. FIG. 11 is a block diagram showing a configuration of the product-sum operation circuit 161b according to the second embodiment. As shown in FIG. 11, the product-sum operation circuit 161b according to the second embodiment includes a register 32 and an initial value canceling circuit 34 instead of the register 22 and the initial value canceling circuit 24. The register 32 is configured by removing the initial value setting unit 23 from the register 22. Also, the initial value canceling circuit 34 is configured by removing the initial value holding unit 25 from the initial value canceling circuit 24. Further, the register 32 and the initial value canceling circuit 34 have a function of changing the initial value based on an initial value provided from outside of the product-sum operation circuit 161b.

In addition, the product-sum operation circuit 161b includes an initial value storage unit 31 that rewritably holds the initial value. The initial value written to the initial value storage unit 31 may be an arbitrary value stored in a built-in storage device formed on the same semiconductor chip as the register 32 or an arbitrary value provided from outside of the semiconductor chip on which the register 32 is formed.

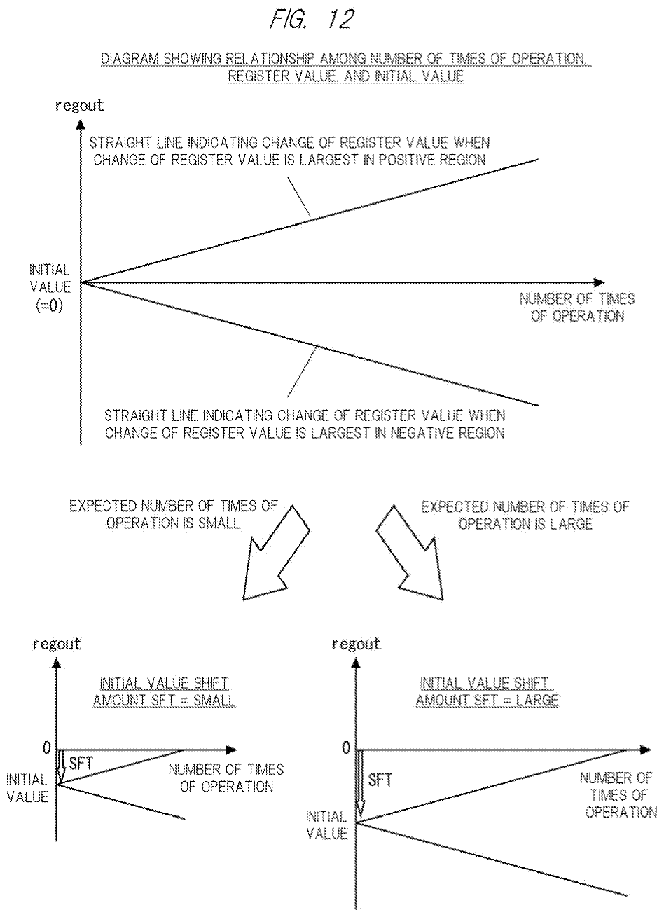

Here, the initial value determination method applied in the second embodiment will be described in detail. First, a first example of the initial value determination method will be described. In the first example, assuming that all weight data are the maximum values set in advance, the initial value size is determined based on the number of processing cycles required to determine the one final output value (hereinafter referred to as the number of times of product-sum operation). FIG. 12 is a diagram for describing the first example of the initial value determination method in the product-sum operation circuit according to the second embodiment.

As shown in FIG. 12, the register value regout increases in both the positive and negative directions as the number of times of operation increases. Therefore, when the expected number of times of operation is small, the shift amount of the initial value from zero is made small, and when the expected number of times of operation is large, the shift amount of the initial value from zero is made large. Also, when using the initial value shifted in the negative direction, the toggle rate can be reduced by setting the initial value size such that the maximum value of the register value regout on the positive side is less than zero. Further, when using the initial value shifted in the positive direction, the toggle rate can be reduced by setting the initial value size such that the minimum value of the register value regout on the negative side is equal to or larger than zero. Note that, since the number of bits of the register to be used can be reduced by reducing the shift amount of the initial value from zero, the amount of reduction in power consumption can be increased.

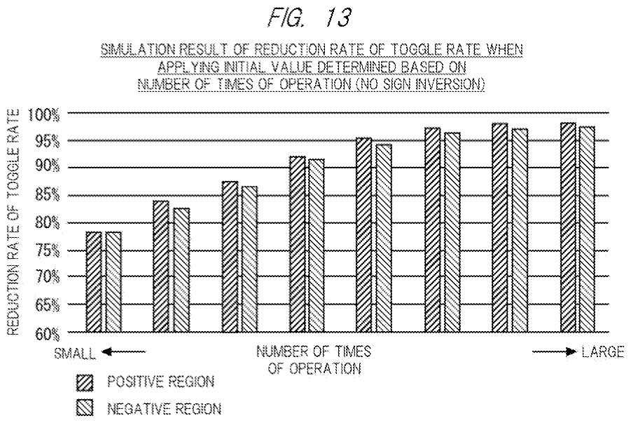

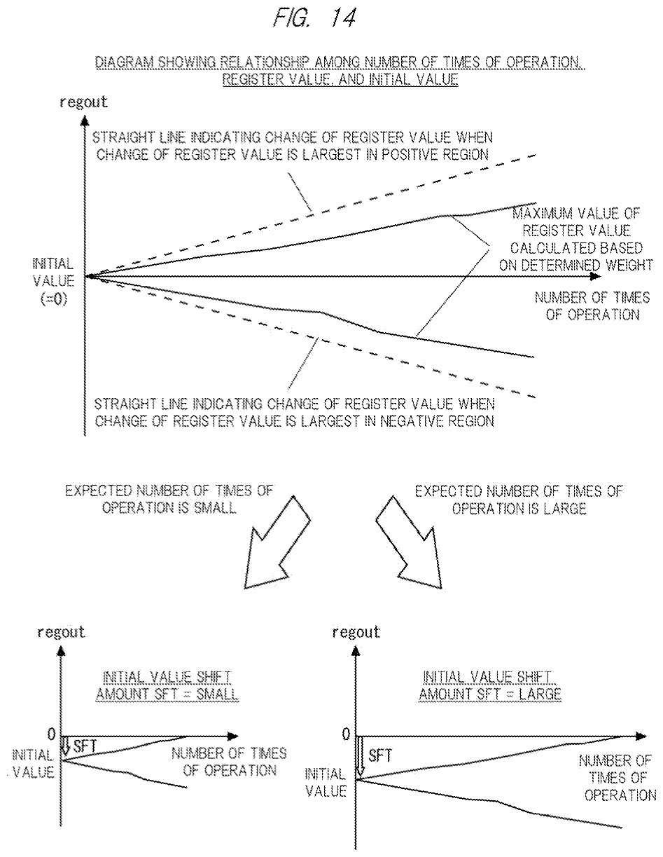

Next, FIG. 13 is a diagram for describing the toggle rate in the case of applying the first example of the initial value determination method. In this figure, the number of toggles of the register value regout that occur in the product-sum operation when the initial value is set to zero is defined as 100%, and the reduction rates of the toggle rate when the initial value is determined based on the number of times of operation in the same operation are shown as bar graphs. Further, FIG. 13 shows the reduction rates of the toggle rate when the initial value is shifted in the positive direction and the reduction rates of the toggle rate when the initial value is shifted in the negative direction. Note that the results shown in FIG. 13 are the simulation results. Furthermore, this simulation is performed on the assumption that no sign inversion occurs when the initial value is shifted.

As shown in FIG. 13, it can be seen that the reduction rate of toggle rate increases as the number of times of operation becomes smaller when the initial value is determined based on the number of times of operation, but a certain reduction rate of toggle rate is obtained even when the number of times of operation increases.

Next, the second example of the initial value determination method will be described. In the second example, the maximum value of the register value regout is calculated for each number of times of operation in consideration of the size of the actual weight data, and the initial value size is determined based on the maximum value of the register value regout and the number of times of product-sum operation. FIG. 14 is a diagram for describing the second example of the initial value determination method in the product-sum operation circuit according to the second embodiment.

As shown in FIG. 14, when the actual weight data is taken into consideration, the maximum value of the register value regout is smaller than that of the case where the weight data is fixed at the maximum value on both the positive and negative sides. Also in the second example, the register value regout increases in both the positive and negative directions as the number of times of operation increases. Therefore, as in the first example, when the expected number of times of operation is small, the shift amount of the initial value from zero is made small, and when the expected number of times of operation is large, the shift amount of the initial value from zero is made large. Furthermore, when using the initial value shifted in the negative direction, the toggle rate can be reduced by setting the initial value size such that the maximum value of the register value regout on the positive side is less than zero. Furthermore, when using the initial value shifted in the positive direction, the toggle rate can be reduced by setting the initial value size such that the minimum value of the register value regout on the negative side is equal to or larger than zero.

Here, in the second example, the shift amount of the initial value is smaller than that in the first example. Since the number of bits of the register to be used can be reduced by reducing the shift amount of the initial value from zero, the amount of reduction in power consumption can be increased. In other words, by adopting the second example, it is possible to obtain the higher power consumption reduction effect than that in the first example.

Next, FIG. 15 is a diagram for describing the toggle rate in the case of applying the second example of the initial value determination method. In this figure, the number of toggles of the register value regout that occur in the product-sum operation when the initial value is set to zero is defined as 100%, and the reduction rates of the toggle rate when the initial value is determined based on the number of times of operation in the same operation are shown as bar graphs. Further, FIG. 15 shows the reduction rates of the toggle rate when the initial value is shifted in the positive direction and the reduction rates of the toggle rate when the initial value is shifted in the negative direction. Note that the results shown in FIG. 15 are the simulation results. Furthermore, this simulation is performed on the assumption that no sign inversion occurs when the initial value is shifted.

As shown in FIG. 15, it can be seen that the reduction rate of toggle rate increases as the number of times of operation becomes smaller when the initial value is determined based on the number of times of operation, but a certain reduction rate of toggle rate is obtained even when the number of times of operation increases. Further, it can be seen that the effect of suppressing the toggle rate when the number of times of operation increases is higher in the second example as compared with the first example.

From the above description, by adopting the initial value determination method according to the second embodiment, it is possible not only to suppress the inversion of the register value regout but also to suppress the number of register circuits to be used, and it is thus possible to obtain a higher power consumption reduction effect than that of the product-sum operation circuit 161 according to the first embodiment.

### Third Embodiment

In the third embodiment, a product-sum operation circuit 161c, which is another form of the product-sum operation circuit 161b according to the second embodiment, will be described. In the description of the third embodiment, the same components as those in the first and second embodiments are denoted by the same reference characters as those in the first and second embodiments, and the description thereof will be omitted.

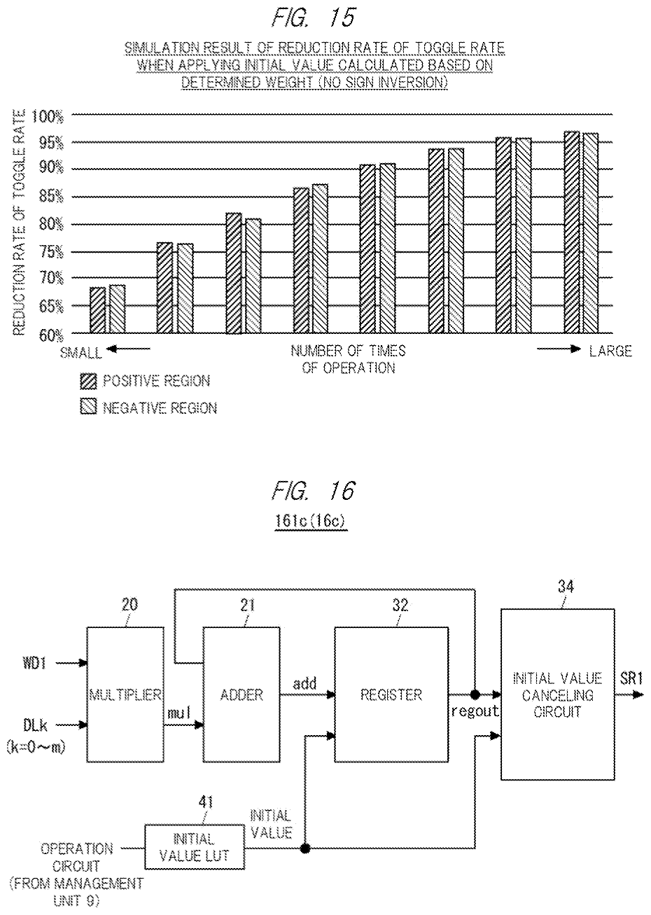

FIG. 16 is a block diagram showing a configuration of a product-sum operation circuit according to the third embodiment. As shown in FIG. 16, the product-sum operation circuit 161c according to the third embodiment is obtained by removing the initial value storage unit 31 of the product-sum operation circuit 161b according to the second embodiment and adding an initial value lookup table 41. The initial value lookup table 41 is configured to hold, for example, a lookup table showing the relationship between the initial value determined by the initial value determination method according to the second embodiment and the number of times of operation. Then, for example, based on the number of times of operation provided from the management unit 9, an initial value corresponding to the number of times of operation is output.

Since such a lookup table can be prepared in advance if the weight data and the structure of the neural network are known, the operations required to calculate the initial value can be omitted by using the initial value lookup table 41.

### Fourth Embodiment

In the fourth embodiment, a product-sum operation circuit 161d, which is another form of the product-sum operation circuit 161c according to the third embodiment, will be described. In the description of the fourth embodiment, the same components as those in the first to third embodiments are denoted by the same reference characters as those in the first to third embodiments, and the description thereof will be omitted.

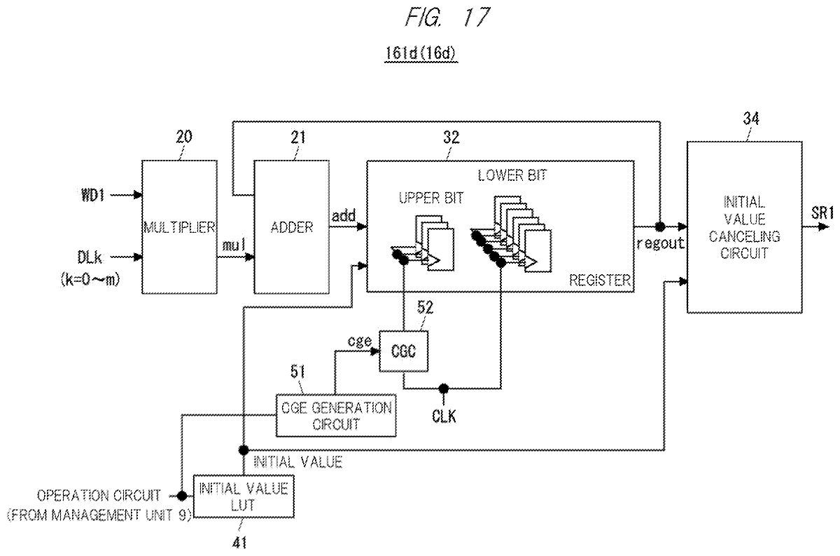

FIG. 17 is a block diagram showing a configuration of the product-sum operation circuit 161d according to the fourth embodiment. As shown in FIG. 17, the product-sum operation circuit 161d according to the fourth embodiment is obtained by adding a clock gating enable generation circuit 51 and a clock gating circuit 52 to the product-sum operation circuit 161c according to the third embodiment. In FIG. 17, a D flip-flop that is included in the register 32 and holds one bit of the bits constituting the register value regout is clearly shown. Then, the clock gating enable generation circuit 51 determines the D flip-flop to which a clock signal CLK is supplied based on the number of times of operations provided from the management unit 9, and outputs a clock gating enable signal cge that specifies the D flip-flop to which the clock signal CLK is supplied. The clock gating circuit 52 partially stops the clock signals CLK supplied to the plurality of D flip-flops in accordance with the clock gating enable signal cge. Note that some of the D flip-flops for holding values corresponding to the lower bits of the register value regout are directly supplied with the clock signals CLK without going through the clock gating circuit 52. Some of the D flip-flops for holding values corresponding to the upper bits are supplied with the clock signals CLK through the clock gating circuit 52. The clock gating enable generation circuit 51 generates the clock gating enable signal cge such that the number of D flip-flops to which supply of the clock signals CLK is stopped increases as the number of times of operation provided from the management unit 9 decreases (that is, the initial value decreases).

As described in the second and third embodiments, the number of bits in which the toggle does not occur increases or decreases depending on the initial value size. Therefore, by stopping the clock signals CLK supplied to the D flip-flops corresponding to the bits in which the toggle does not occur by using the clock gating enable generation circuit 51 and the clock gating circuit 52, the semiconductor device according to the fourth embodiment can further reduce the power consumption as compared with the first to third embodiments.

### Fifth Embodiment

In the fifth embodiment, a product-sum operation circuit 161e, which is another form of the product-sum operation circuit 161c according to the second embodiment, will be described. In the description of the fifth embodiment, the same components as those in the first and second embodiments are denoted by the same reference characters as those in the first and second embodiments, and the description thereof will be omitted.

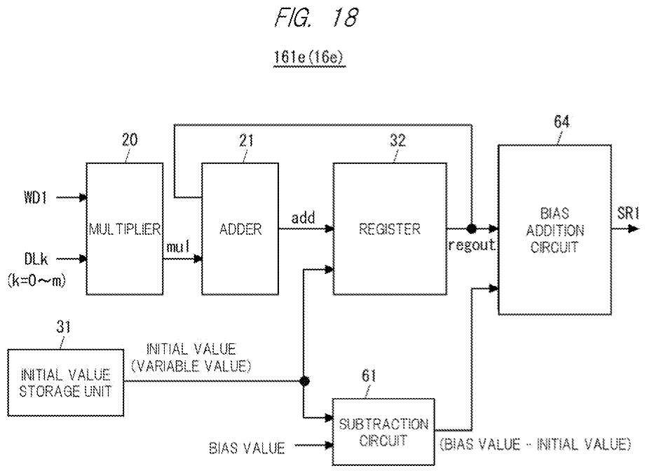

FIG. 18 is a block diagram showing a configuration of the product-sum operation circuit 161e according to the fifth embodiment. As shown in FIG. 18, the product-sum operation circuit 161e according to the fifth embodiment is obtained by replacing the initial value canceling circuit 34 with a bias addition circuit 64 and further adding a subtraction circuit 61.

The subtraction circuit 61 subtracts the initial value from a preset bias value. The bias addition circuit 64 is configured by adding the function of adding the bias value to the initial value canceling circuit 34. Namely, the bias addition circuit 64 cancels the initial value from the cumulative value by the output value of the subtraction circuit, and outputs a value obtained by adding the bias value to the cumulative value after canceling the initial value as the final output value.

The bias addition is a function that is implemented in accordance with the product specifications. By calculating the value obtained by subtracting the initial value from the bias value by providing the subtraction circuit 61 and providing the calculated value to the bias addition circuit 64 as a new bias value, the addition of the bias value to the register value regout and the cancellation of the initial value can be performed. The increase in circuit scale due to the addition of the subtraction circuit 61 and the specification change of the bias addition circuit 64 is very small and can be ignored.

In the foregoing, the invention made by the inventors of this application has been specifically described based on the embodiments, but it goes without saying that the present invention is not limited to the embodiments described above and various modifications can be made within the range not departing from the gist thereof.

What is claimed is:

1. A semiconductor device comprising:
a multiplier configured to calculate a product of first data and second data whose values change for each processing cycle;
a register configured to hold a value obtained by updating a cumulative value of output values of the multiplier for each processing cycle and output it as a register value;
an adder configured to add the output value of the multiplier and the register value to update the cumulative value;
an initial value setting unit configured to provide an initial value of the register value; and
an initial value canceling circuit configured to cancel the initial value contained in the register value and output a final output value,
wherein the initial value setting unit sets a positive or negative value other than zero as the initial value.

2. The semiconductor device according to claim 1,
wherein the initial value is set to such a size that a sign of the cumulative value is not inverted in the processing cycles until the one final output value is determined.

3. The semiconductor device according to claim 1,
wherein the initial value setting unit resets the register value to the initial value by a preset fixed value when resetting the register.

4. The semiconductor device according to claim 1,
wherein the initial value setting unit is a selector configured to provide the initial value to the adder in a first processing cycle of the processing cycles and provide the register value to the adder in second and subsequent processing cycles of the processing cycles.

5. The semiconductor device according to claim 1,
wherein the initial value is an arbitrary value stored in a built-in storage device formed on the same semiconductor chip as the register or an arbitrary value provided from outside of the semiconductor chip on which the register is formed.

6. The semiconductor device according to claim 1,
wherein the initial value is determined based on the number of processing cycles required to determine the one final output value.

7. The semiconductor device according to claim 1, further comprising a lookup table configured to store a correspondence relationship between the number of processing cycles required to determine the one final output value and the initial value,
wherein the lookup table provides the initial value stored in accordance with the number of processing cycles required to determine the one final output value to the register and the initial value canceling circuit.

8. The semiconductor device according to claim 1,
wherein the first data is a value changed sequentially from a predetermined value for each processing cycle, and
wherein the initial value is determined by the number of processing cycles required to determine the one final output value and a maximum or minimum value of the final output value determined by the first data.

9. The semiconductor device according to claim 1, further comprising a clock gating circuit configured to partially stops clock signals supplied to a plurality of D flip-flops each holding one bit indicating the cumulative value in the register, based on a size of the initial value,
wherein the clock gating circuit increases the number of D flip-flops to which supply of the clock signals is stopped as the initial value decreases.

10. The semiconductor device according to claim 1, further comprising a subtraction circuit configured to subtract the initial value from a preset bias value,
wherein the initial value canceling circuit cancels the initial value from the cumulative value by an output value of the subtraction circuit, and outputs a value obtained by adding the bias value to the cumulative value after canceling the initial value as the final output value.

11. The semiconductor device according to claim 1,
wherein the first data is weight data to be a coupling coefficient between neurons in machine learning, and
wherein the second data is an output value output by a neuron defined in a one previous processing layer in machine learning.
